(19) United States
(12) Patent Application Publication
(10) Pub. No.: US 2023/0232755 A1
(43) Pub. Date: Jul. 27, 2023

(54) STRIP OF SUBSTANTIALLY FLAT PLANT CLIPS THAT ARE INTEGRALLY CONNECTED WITH EACH OTHER

(71) Applicant: Joost Arie De Jong, Honselersdijk (NL)

(72) Inventor: Joost Arie De Jong, Honselersdijk (NL)

(21) Appl. No.: 17/928,689

(22) PCT Filed: Jun. 29, 2021
(86) PCT No.: PCT/EP2021/067906

§ 371 Date: Nov. 30, 2022

(30) Foreign Application Priority Data
Jun. 30, 2020 (NL) 2025956

(51) Int. Cl. A01G 9/12; F16B 2/22

(52) U.S. Cl. CPC A01G 9/128; F16B 2/22

(57) ABSTRACT

An assembly of plant clips for connecting plant stems to elongate supports, like rods or wires, each plant clip includes a clip body delimiting a holding space for taking in and holding the plant stem and elongate support, where free ends of each clip body form inwardly directed hook-shaped legs that together delimit an insertion opening for the plant stem and elongate support to enter into the holding space. The clip bodies together form a strip of integrally connected substantially flat plant clips.

### CROSS-REFERENCE TO RELATED APPLICATIONS

This application is the National Stage of International Application No. PCT/EP2021/067906, filed Jun. 29, 2021, which claims the benefit of Netherlands Application No. 2025956, filed Jun. 30, 2020, the contents of which is incorporated by reference herein.

### FIELD OF THE INVENTION

The present invention relates to plant clips for connecting plant stems to elongate supports, like rods or wires, such that the plant stems get properly supported during a growing phase.

### BACKGROUND TO THE INVENTION

Plant clips are known in a variety of shapes, and nowadays mostly are made out of plastic by means of injection moulding. They are well known to comprise a split ring shaped clip body that delimits a mainly round holding space for taking in and holding a plant stem and elongate support, wherein the split ring shaped clip body has two inwardly directed hook-shaped legs at its free ends that together delimit an insertion opening for the plant stem and elongate support to enter into the holding space. With that the two opposing inwardly directed hook-shapes, at both sides of the insertion opening, help to maintain the plant stem and elongate support within the holding space, particularly when the plant stem keeps on growing and because of that may start to push the legs apart and thus inadvertently widen the insertion opening.

A disadvantage of the known plastic plant clips is that although they are quite cheap, their user-friendliness and environmental impact leaves to be improved, particularly when used by professional growers that are known to use them in truly large numbers.

For example, in the field of temporarily clipping stems of young tomato plants to support rods that are pinned sideways to the tomato plant stems into substrate material the plants are growing in, it concerns more than 20 million plastic plant clips per year for only the Netherlands. For other types of plants also large numbers of plastic plant clips are used. All together this leads to a huge amount of plastic waste and the costs for professional growers having to deal therewith keep on getting higher. With this it is noted that for some types of plants, like the young tomato plants, the functionality of the clips is only necessary for a limited amount of time, for the young tomato plants merely about two weeks. After that the young tomato plants are destined to keep on growing further upwards while being guided along a wire. This limited amount of time makes the negative impact on the environment of the only shortly used plastic plant clips even harder to accept.

Another disadvantage is that after being injection moulded, the plastic plant clips are loosely deposited at certain weights/amounts in packagings. A grower then can take the plant clips out by the piece and each time manipulate a new one around the plant stem—elongate support. With this however it frequently occurs that the plant clips inside the packaging are entangled with each other. This then makes it necessary for the grower to over and over again free new plant clips from out of such entanglements. This is not only time-consuming, but also quite frustrating.

Furthermore, it is a difficult handling when one has only one hand available to free a new plant clip, for example because the other hand may already be occupied in holding a plant stem and elongate support closely together for subsequently placing the plant clip around them.

Further it is noted that, during placing, the legs need to be manually pushed away from each other in opposing sideways directions in order to facilitate the entering of a plant stem and elongate support. This is important because of the vulnerability of the plant stem that in no way may get damaged during this, which quickly may occur when the soft living tissue material of the plant stem gets forced to move relative to sharp and/or hard edges/points of the relative rigid plant clip.

The opening up of the relative rigid plastic plant clip may be relative difficult to do, particularly when one only has one hand available. For that it is known to provide the plastic plant clip with backwardly projecting pinching handles that upon being pinched together result in opening up the insertion opening by means of the hook-shaped legs moving away from each other.

DE-1.165.335 shows a few possible embodiments of plant clips with clip bodies that have inwardly directed hook-shaped legs delimiting an insertion opening there between that gives access to a holding space. The flexibility of the legs and/or clip body at a location nearby the insertion opening has here been increased by designing them with local weakenings in their cross-sections, such that a plant stem that is placed to extend through the holding space together with an elongate support, that starts to grow and thus become thicker during a growing phase gets less hindered by the legs and clip body of the plant clip surrounding it.

This however makes the manufacturing by injection moulding more demanding, and may result in premature breaking of the plant clip during placing or during the growing phase it needs to be functional. Furthermore, also this type of plastic plant clip still brings along the same problems of plastic waste and difficulties during use resulting from clips hooking into each other and being difficult to separate from each other.

NL-7316387 shows three embodiments of elastically deformable plastic plate-shaped plant clips. Each plate-shaped plant clip is rectangular and comprises one or two round holes that via one or two linear cuts connect towards a semi-circular entrance opening that is provided in one of the side edges. A plant stem and support rod can be inserted into the round holes via the semi-circular entrance opening and the one or two cuts. In the case of slender plant stems and support rods, they can both come to lie inside the same round hole. In the case of thicker plant stems and support rods, one of them can come to lie inside the one round hole, whereas the other one can come to lie in the other round hole.

The placing of the plate-shaped plant clips around plant stems and support rods however leaves to be desired, and may result in a damaging of the plant stem due to all kinds of sharp edges along the semi-circular entrance opening, the one or two linear cuts and the one or two round holes. Furthermore, also this type of plastic plant clip still brings along the same problems of plastic waste and difficulties during use resulting from clips hooking into each other and being difficult to separate from each other.

KR-10-1849614 shows a plastic tie for connecting a plant stem to a supporting wire. The tie is formed by an integral succession of C-shaped ring parts. Any two spaced apart ones of the ring parts can be hooked on the supporting wire, while extending around a plant stem. Thus, account can be taken of varying thickness of plant stems and aimed loose or tight states for the tie to connect the plant stem to the supporting wire.

An easy and quick placing of the ties around plant stems and supporting wires however is not foreseen nor possible. Furthermore, the relative long and complex structure of the plastic ties leads to a lot of waste material, and brings along difficulties during use resulting from ties hooking into each other and being difficult to separate from each other.

### BRIEF DESCRIPTION OF THE INVENTION

The present invention aims to overcome those disadvantages at least partly or to provide a usable alternative. In particular the present invention aims to provide user-friendly plant clips that are quick and easy to handle, economic to manufacture and that preferably can be made out of a biodegradable compostable material.

This aim is achieved by an assembly of plant clips according to the present invention. In this assembly each plant clip comprises a clip body delimiting a holding space for taking in and holding a plant stem and an elongate support, like a rod or wire, wherein free ends of each clip body form inwardly directed hook-shaped legs that together delimit an insertion opening for the plant stem and elongate support to enter into the holding space. According to the inventive thought the clip bodies together form a strip of integrally connected substantially flat clip bodies, wherein each clip body in the strip is integrally connected to its neighboring ones by means of one or more integral connection portions that are configured to tear loose or break free when a tearing or breaking force is exerted on a foremost clip body relative to the rest of the strip.

This advantageously makes it easy for a user to each time quickly grab a new one of the clip bodies and separate it from the strip, for example by tearing or breaking. The plant clips no longer can get entangled with each other. This safes a lot of costly time and frustration for growers who have to clip large amounts of plant stems to elongate supports.

The elongate strip of integrally connected substantially flat plant clips makes it possible to roll them up after manufacturing, distribute them in rolls, and during use unroll them stepwise. In the alternative for the roll form it is also possible to fold the strip up into a bundle of strip segments that have been laid meandering on top of each other. The rolled up or bundled form of the strip of integrally connected substantially flat plant clips makes it possible to place it on some kind of holder that can be positioned at a working station adjacent a worker. The roll or bundle can also be carried directly on one's body, for example the back or hip, such that the worker may walk through the greenhouse and provide those plants that need it with freshly separated new clip bodies from the strip.

Another important advantage of the present invention is that the strip shape makes it possible to use it in combination with a special dispenser device through which a leading portion of the strip can be guided and that is configured to help to individualize the clip bodies. For that such a dispenser device may comprise a sort of guiding channel through which the strip can slide in a feeding direction, and a front separation edge along which the front most clip body can be moved in a transverse direction in order to break free or tear loose from the rest of the strip. Thus a user each time it is desired can quickly and easily pull a new one of the clip bodies out of the dispenser device and then separate it from the rest of the strip. This all can be done without any risk of entanglement with other clip bodies, because all the other clip bodies still are connected with each other in the strip and may still lie protected inside an upstream portion of the dispenser device. Also this can be done without running a risk of damaging the new to be torn loose or broken free one of the clip bodies or the other ones that remain behind on the strip.

A new one of the clip bodies can thus each time easily and quickly get separated from the strip, if needed even with one hand, to then carefully be placed around the plant stem and elongate support.

With strip it is intended to define that the assembly of integrally connected substantially flat clip bodies has an elongate shape and comprises a row of the integrally connected clip bodies that are arranged one behind the other in a longitudinal direction. The strip itself is also substantially flat and of elongate shape.

The number of singulatable clip bodies in the strip may vary, but in line with the inventive thought at least comprises such large numbers of more than three plant clips that intermediate ones of the clip bodies are obtained. Those intermediate ones of the clip bodies then are integrally connected with neighbouring leading and trailing ones of the clip bodies in the strip, both at their front and back ends, by means of the connection members. Preferably, the number of clip bodies in the strip is more than hundred, in particular more than thousand. Owing to the minimum lightweight design of the individual plant clips, the strip then still can be provided in easy to handle and/or carry lengths, for example in rolled-up or folded-up form, and without having to replace it too frequently during work.

In a preferred embodiment, the strip of integrally connected substantially flat plant clips can be made out of a substantially flat base biodegradable natural fibre and/or cardboard paper material, by means of a die cutting operation that has been performed on a substantially flat strip of the biodegradable natural fibre and/or cardboard/paper material. This makes it possible to easily manufacture the strip in an economic manner.

In another preferred embodiment, the strip of integrally connected substantially flat plant clips made out of a biodegradable natural fibre and/or cardboard paper material can be made with a thickness that is smaller than cross-sectional width dimensions of the legs. Owing to such a thin-walled design, the strip can still be rolled up, and a new way of placing the individual plant clips around the vulnerable plant stem and elongate support has become possible. In this new way the legs can be manually flexed in opposing directions perpendicular to the flat face of the clip body instead of in opposing sideways directions as foreseen with the known plant clips. The flat thin-walled shape gives the clip bodies and legs good flexibility in just that perpendicular direction, while having good clipping rigidity in the sideways directions. Thus the clip body advantageously also no longer has to be provided with pinching handles or the like for opening it up in the sideways direction. The clip body itself has become flexible in the perpendicular direction instead. Thus a careful placing without damaging the vulnerable plant stem or the clip body itself has become possible.

In particular the thickness may lie between 0.4-1 mm, whereas the cross-sectional width dimensions of the legs lies between 3-7 mm. This has appeared to provide the clip body with a good optimal combination of rigidity and flexibility, while also being able to roll up the strip of plant clips.

In a preferred further or alternative embodiment, the strip of integrally connected substantially flat plant clips can now be made out of a non-plastic material, in particular out of a biodegradable natural fibre and/or cardboard/paper material. This makes the plant clips not only well recyclable, but also is an economic manufacturing material, that makes the individual clip bodies compostable after use which is much better for the environment than the millions of plastic plant clips that are thrown away nowadays. Also it can save considerable costs in waste streams for professional plant growers. The strip of plant clips can even be partly or entirely made out of rest material of the same type of plants they are to be used upon themselves, like tomato plant stem fibres. Thus a step closer to circular horticulture can be obtained. The biodegradable natural fibre and/or cardboard/paper material has appeared to be well able to have the plant clip fulfil its main function, that is to say to reliably hold the plant stem and elongate support closely together during a growing phase of the plant without hindering this growth whatsoever. Further it is noted that the natural fibre and/or cardboard/paper material perfectly fits with the abovementioned manufacturing method of die-cutting the strip of plant clips out of a strip of base material.

Preferably a biodegradable natural fibre and/or cardboard/paper material with long natural fibers is used, also referred to as virgin fiber, such that even when the clip body is thin-walled it can remain sufficiently strong.

Preferably the biodegradable natural fibre and/or cardboard/paper material is at least of a 400 grams/m2 type. This has appeared strong enough while the assembly of plant clips then still can be rolled-up as a strip of integrally connected substantially flat clip bodies.

For example the strip of plant clips is primarily made out of wood fibres. This offers the strip of plant clips an optimized strength/weight ratio, makes it lightweight without compromising on the clipping performance, and makes it possible to neatly have it die cut while also being able to easily manually tear the plant clips apart.

In a preferred further or alternative embodiment, the clip bodies in the strip may lie with their insertion openings in a longitudinal direction of the strip, in particular facing away from a feed direction. This offers the advantage that the strip is well able to maintain its strength in longitudinal direction and does not get stretched, deformed or even damaged when a new one of the clip bodies gets pulled out of the dispenser and/or gets removed from the strip.

In a preferred further or alternative embodiment, each clip body in the strip may be integrally connected to its neighboring ones by means of one or more integral connection portions, in particular by means of sideways spaced apart and/or narrowing and/or weakened connection portions that extend between each pair of neighboring clip bodies. Those connection portions are configured to tear loose or break free when a large enough tearing or breaking force is exerted on the foremost clip body relative to the rest of the strip. For example this can be done by gripping the foremost clip body and exerting a pulling force thereupon, preferably along a front separation edge of the abovementioned dispenser device. The connection portions thus are the first ones to collapse.

In the case of pairs of spaced apart connection portions extending in between the respective clip bodies, a gap is delimited between the connection portions and the respective clip bodies. This gap can for example be made during the die cutting of the strip of integrally connected substantially flat plant clips. Thus the connection portions can easily be made relative small and thin-walled which further facilitates the tearing loose or breaking free of a new one of the clip bodies from the rest of the strip along those slender connection portions.

Advantageously, the connection portions do not merely extend in between the clip bodies but may also be configured to project sideways past by arc-shaped circumferential outer edges of the clip bodies. The thus sideways projecting connection portions then may form guiding tabs, in particular configured to neatly guide the strip between sidewalls of a dispenser channel of the abovementioned dispenser device without getting stuck therein.

When the clip bodies lie with their insertion openings in a longitudinal direction of the strip, two of the connection portions can be provided at opposing sides of each insertion opening between the neighboring clip bodies. Remainders of the connection portions that after separation of a clip body remain integrally connected to that clip body then may form outwardly projecting manually operable gripping ears. Those gripping ears then can be used to facilitate the flexing of the legs in the direction perpendicular to the substantially flat face of the clip body.

In a preferred further or alternative embodiment, each plant clip in the strip may comprise a ring-segment shaped clip body. The rounded shape helps to protect the vulnerable plant stem, gives the clip body good rigidity in the directions of its substantially flat face, and prevents the clip body from having sharp edged cornered transitions where it otherwise may be prone to get prematurely damaged during its tearing loose or breaking free or during its flexing open upon placement.

For example the ring-segment shaped clip body may have an inner diameter of between 10-25 mm and a local ring width of between 3-7 mm.

Preferably, the ring-segment shaped clip body may cover more than half a circle, and in particular extend along between 270-355 degrees of a circle.

The invention also relates to a use of the strip of integrally connected substantially flat plant clips as well as to a method for manufacturing them.

Further preferred embodiments of the invention are described herein.

### BRIEF DESCRIPTION OF THE DRAWINGS

The invention shall now be explained in more detail below by means of describing some exemplary embodiments in a non-limiting way with reference to the accompanying drawings, in which:

FIG. 1 shows a schematic perspective view of a portion of a strip of plant clips according to the invention;

FIGS. 2a and 2b show a perspective and a top view of a separated one of the clip bodies of FIG. 1;

FIG. 3 shows a dispenser device for separating the clip bodies from the strip of FIG. 1; and

FIGS. 4a-c shows three subsequent phases of pulling out and separating a new one of the clip bodies out of the dispenser device of FIG. 3; and

FIG. 5 shows one of the clip bodies separated from the strip of FIG. 1 placed around a plant stem and support rod.

### DETAILED DESCRIPTION OF THE INVENTION

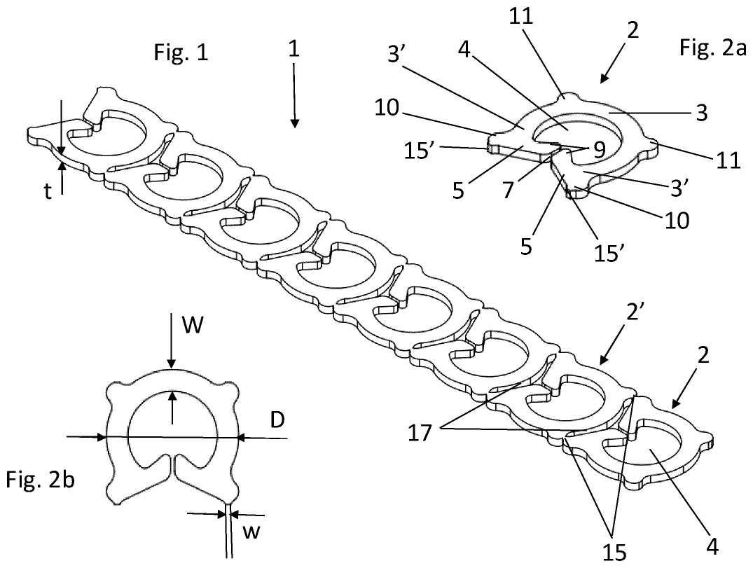

In FIG. 1 a portion of an elongate strip is shown that has been given the reference numeral 1. The strip 1 comprises a repetitive pattern of plant clips 2, here eight of them in a row. This repetitive pattern of plant clips 2 is obtained by means of a die-cutting operation performed on a substantially flat strip of paper material.

The plant clips 2 each exist of a ring-shaped clip body 3 that covers about three quarters of a circle here. Cut-out holding spaces 4 are delimited inside the bodies 3. These holding spaces 4 for a large part are round. Legs 5 are provided at free ends 3′ of the ring-shaped clip bodies 3. All the bodies 3 and legs 5 lie in a same flat face. The legs 5 extend mainly in directions cross to tangential directions of their respective free ends 3′ of the bodies 3, and are connected halfway to the free ends 3′ of the bodies 3.

Inner portions of the legs 5 form opposing hooks 9 that are directed inwardly into the holding spaces 4. Thus a catch opening is created for each plant clip 2. Between the hooks 9, cut-out slit-shaped insertion openings 7 are delimited. Those insertion openings between the free ends of each clip body 3 preferably may have a width that lies between 0-5 mm.

Outer portions of the legs 5 form pairs of trailing left and right rounded guiding tabs 10 that lie at a same distance D as the diameter of the ring-shaped clip bodies 3. The guiding tabs 10 lie at opposing sideways positions of the insertion openings 7.

At diametrically opposite positions along the ring-shaped clip bodies 3, pairs of leading left and right rounded guiding tabs 11 are provided that also lie at a same distance as the diameter of the ring-shaped clip bodies 3.

Besides projecting sideways of the ring-shaped clip bodies 3, the guiding tabs 10, 11 also project in the longitudinal direction of the strip 1. There where the trailing pairs of guiding tabs 10 meet the leading pairs of guiding tabs 11, they integrally connect with cq merge into each other for together forming integral connection portions 15. As can be seen those connection portions 15 are kept small, in particular with a width w that is less than half a width W of the mainly rectangular cross-sections of the ring-shaped clip body 3 and legs 5. This results in the connection portions 15 being the first ones to start tearing when a large enough pulling force is exerted upon a foremost one of the plant clips 2 relative to the rest of the strip 5.

Cut-out arc-shaped gaps 17 extend between the pairs of spaced apart connection portions 15 and the leading and trailing sides of the neighboring plant clips 2. Those gaps 17 are in open condition with the insertion openings 7 and holding spaces 4.

The clip bodies 3 thus lie with their insertion openings 7 projecting forwardly in the strip 1. This has the advantage that this helps to minimize undesired deformation of the clip bodies 3 in the strip 1 to occur. This is achieved due to symmetric left and right free ends 3′ of the substantially C-shaped clip bodies 3 that lie at opposing left and right sides of the holding spaces 4 and insertion openings 7, then get evenly loaded with pulling forces exerted on foremost ones of the clip bodies 3. This is in contrast to a strip of clip bodies in which the insertion openings would open out sideways, that is to say perpendicular to the longitudinal direction of the strip, because there a pulling force on a foremost one of the clip bodies could easily lead to the free ends of the substantially C-shaped clip bodies that then have come to lie at opposing front and back sides of the holding spaces and insertion openings, then would get pulled away from each other while widening the insertion openings and possibly damaging the clip bodies due to tearing or overstretching.

The thickness t of the plant clips 2 is also less than half the width W of the cross-sections of the ring-shaped clip bodies 3 and legs 5. This causes the free ends 3′ of the ring-shaped clip bodies 3 and the legs 5 to more easily flex upwards or downwards that is to say in a direction perpendicular to the flat face of the plant clips 2.

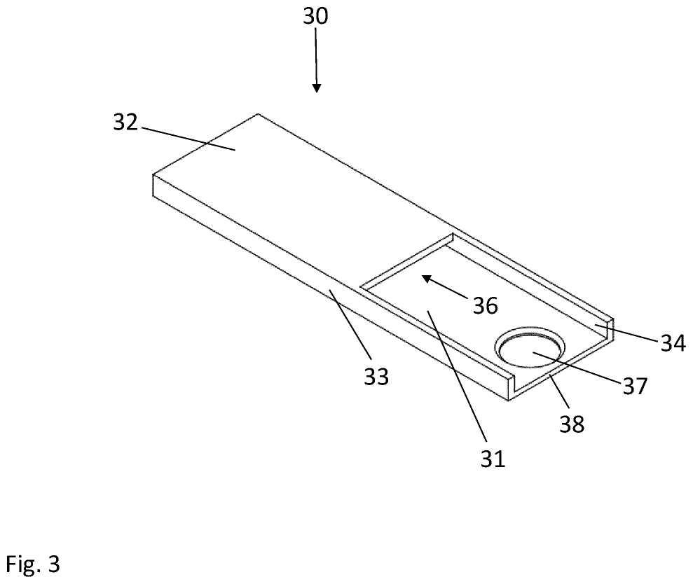

In FIGS. 2a and 2b a plant clip 2 according to the invention is shown that just has been torn loose from a leading end of the strip 1. It can be seen there that the connection portions 15 are still somewhat visible as substantially straight tearing edges 15′ on the outer portions of the legs 5 cq trailing guiding tabs 10. Being made out of paper, those left behind tearing edges 15′ are non-sharp nor pointed and thus do not form a risk for accidentally damaging a plant stem during placing. Further it can be seen there that the plant clip 2 merely comprises concavely or convexly curved or straight circumferential inner and outer edges and thus also does not form a risk for accidentally damaging a plant stem with its circumferential edges during placing.

In FIG. 3 a dispenser device 30 is shown. The dispenser device 30 comprises a bottom wall 31, a top wall 32 and side walls 33, 34 that together delimit a dispenser channel 36 that has a width that is slightly larger than the outer diameter D of ring-shaped clip body 3 respectively the sideways distances between the guiding tabs 10, 11, and that has a height that is slightly larger than the thickness t of the strip 1. At is front portion the device's top side is left open. In the bottom wall 31 of the open front portion a circular opening 37 is provided. The front portion comprises a separation edge 38 at its front side.

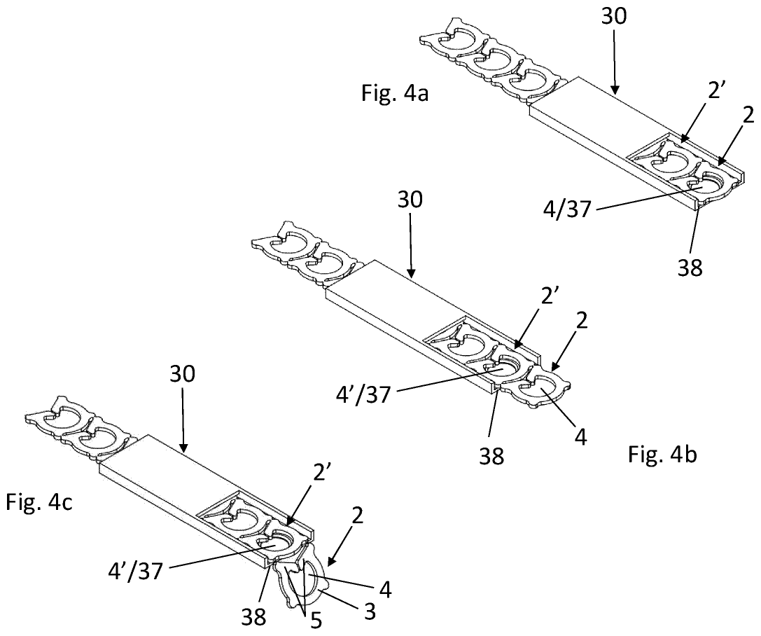

In FIG. 4a it is shown that a front part of the strip 1 has been guided into the channel 36 of the dispenser device 30 until its foremost plant clip 2 has come to lie against the separation edge 38. With that, the holding space 4 of the foremost plant clip 2 lies above the opening 37.

In FIG. 4b it is shown that the foremost plant clip 2 is pulled out of the dispenser device 30 until the connection portions 15 with the subsequent plant clip 2′ have come to lie right above the separation edge 38.

In FIG. 4c it is shown that the foremost plant clip 2 gets folded down along the separation edge 38 in order to tear it loose from the subsequent plant clip 2′. With this a user can easily keep the subsequent plant clip 2′ in place by sticking a finger through the opening 37 and through the holding space 4′ of the subsequent plant clip 2′.

This process can be repeated as many times as desired each time a new plant clip 2 is to be released from the strip 1.

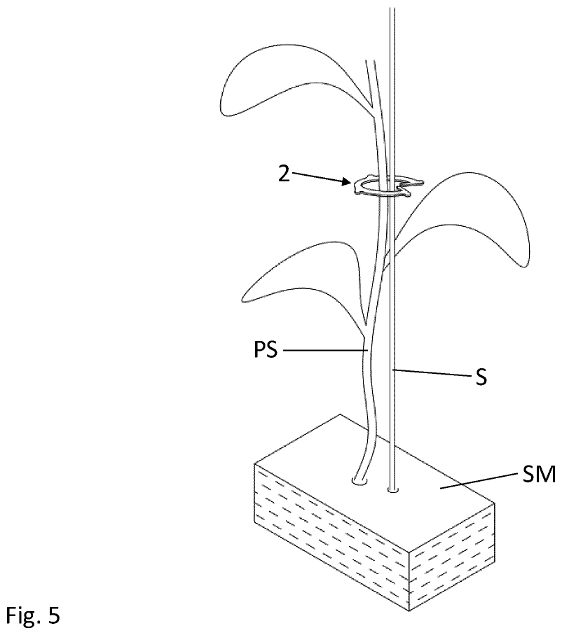

In FIG. 5 it is shown that the thus released plant clip 2 has been placed around a plant stem PS and a rigid support rod S that has been stuck into substrate material SM next aside the plant stem PS. Owing to the relative soft material capacities the substantially flat plant clip can quickly and easily be flexed open such that it can be slid with its widened insertion opening over the plant stem PS and support rod S that then come to extend through the holding space 4 and are effectively kept therein by the hooks 9.

During a subsequent growing phase the plant clips 2 are well able to keep the plant stem PS properly supported near the support rod S. During that the holding space 4 is dimensioned large enough for the plant stem PS to grow thicker without being hindered by the plant clip 2 as well as for the plant clip 2 to slide upwards along the support rod SR together with the plant growing in height.

After the growing phase has ended the plant clip 2 can easily be removed for example by tearing, cutting, folding it open.

Besides the shown and described embodiments, numerous variants are possible. For example the dimensions and shapes of the various clip portions can be altered. Instead of using paper other kinds of material can be used, including plastic, if it for example is aimed to re-use the clips over and over again. Instead of ring-shaped bodies, the plant clips may also comprise other outer or inner shapes for its clip bodies, like oval or squared.

Instead of the shown eight, the number of clip bodies in the strip may be any desired number and the strip may have any desired length. Preferably at least about ten clip bodies are comprised in each strip segment. The strips than can be provided in relative short segments, that can be shipped together, for example bundled or stacked in a box. More preferably, the number of clip bodies in the strip is way larger than ten, for example more than hundred, in particular a couple of hundreds or even more than thousand. In that case the length of the strip becomes such large that it can be shipped in rolled-up or folded-up form. With this it is noted that the rolling up or folding up can easily be done owing to the presence of the connection members. There, at the location of the connection members, the transitions between respective neighbouring ones of the clip bodies is weakest. A risk of the connection members prematurely breaking or tearing loose due to such rolling up or folding up does not have to exist owing to the non-brittle material characteristics of the biodegradable natural fibre and/or cardboard/paper material the strips are made of. Other materials are however also possible.

It should be understood that various changes and modifications to the presently preferred embodiments can be made without departing from the scope of the invention, and therefore will be apparent to those skilled in the art. It is therefore intended that such changes and modifications be covered by the appended claims.

1. An assembly of plant clips for connecting plant stems to elongate supports, like rods or wires, each plant clip comprising:
a clip body delimiting a holding space for taking in and holding the plant stem and elongate support,
wherein free ends of each clip body form inwardly directed hook-shaped legs that together delimit an insertion opening for the plant stem and elongate support to enter into the holding space,
wherein the clip bodies together form a strip of integrally connected substantially flat plant clips, and
wherein each clip body in the strip is integrally connected to its neighboring ones by means of one or more integral connection portions that are configured to tear loose or break free when a tearing or breaking force is exerted on a foremost clip body relative to the rest of the strip.

2. The assembly of plant clips according to claim 1, wherein the strip of integrally connected substantially flat plant clips is made out of a biodegradable natural fibre and/or cardboard paper material.

3. The assembly of plant clips according to claim 2, wherein the biodegradable natural fibre and/or cardboard/paper material is at least of a 400 grams/m2 type.

4. The assembly of plant clips according to claim 2, wherein the strip of integrally connected substantially flat plant clips is made out of a substantially flat base biodegradable natural fibre and/or cardboard paper material, by means of a die cutting operation that has been performed on a substantially flat strip of the biodegradable natural fibre and/or cardboard/paper material.

5. The assembly of plant clips according to claim 4, wherein the strip of integrally connected substantially flat plant clips made out of a biodegradable natural fibre and/or cardboard paper material is thin-walled, in particular with a thickness smaller than half a cross-sectional width of the free ends of the clip bodies.

6. The assembly of plant clips according to claim 1, wherein the strip of integrally connected substantially flat plant clips is wound on a roll or is folded up into a bundle of strip segments that have been laid meandering on top of each other.

7. The assembly of plant clips according to claim 1, wherein the clip bodies lie with their insertion openings in a longitudinal direction of the strip, in particular facing away from a feed direction.

8. The assembly of plant clips according to claim 1, wherein the connection portions are sideways spaced apart connection portions between which a gap is provided.

9. The assembly of plant clips according to claim 7, wherein the sideways spaced apart connection portions are provided at opposing sides of each insertion opening between neighboring ones of the clip bodies.

10. The assembly of plant clips according to claim 9, wherein the gaps that extend between the pairs of spaced apart connection portions and leading and trailing sides of neighboring ones of the plant clips, are in open condition with the insertion openings and holding spaces.

11. The assembly of plant clips according to claim 8, wherein the sideways spaced apart ones of the connection portions form part of outwardly projecting guiding tabs configured to guide the strip between sidewalls of a dispenser channel of a dispenser device, and/or wherein two of the connection portions that are provided at opposing sides of the insertion opening form outwardly projecting manually operable gripping ears.

12. The assembly of plant clips according to claim 11, wherein outer portions of the legs form pairs of trailing left and right ones of the guiding tabs, and wherein at opposite positions along the clip bodies, pairs of leading left and right ones of the guiding tabs are provided.

13. The assembly of plant clips according to claim 12, wherein there where the trailing pairs of guiding tabs of one of the clip bodies in the strip meet the leading pairs of guiding tabs of a neighbouring one of the clip bodies in the strip, they integrally connect with cq merge into each other for together forming the integral connection portions.

14. The assembly of plant clips according to claim 1, wherein the insertion openings between the free ends of each clip body in the strip has a width that lies between 0-5 mm.

15. The assembly of plant clips according to claim 1, wherein each plant clip in the strip comprises a ring-segment shaped clip body, that in particular extends along between 180-270 degrees of a circle.

16. The assembly of plant clips according to claim 1, wherein opposing ends of the legs project outwardly past by arc-shaped circumferential outer edges of the clip bodies.

17. A method for connecting plant stems to elongate supports, comprising:
utilizing the assembly of plant clips according to claim 1 for connecting plant stems to elongate supports, like rods or wires, wherein a new one of the clip bodies each time gets separated from the strip, and then the plant stem and elongate support are manipulated via the insertion opening into the holding space of that clip body, in particular while manually flexing the legs in opposing directions perpendicular to the substantially flat clip body.

18. The method according to claim 17 in combination with a dispenser device, wherein a leading part of the strip is guided through a dispenser channel for each time pulling out a new one of the clip bodies out of the dispenser channel and separating it from the rest of the strip, in particular along a front edge of the dispenser.

19. (canceled)

20. A method for manufacturing the assembly of plant clips according to claim 1, comprising the steps of:
supplying a layer of substantially flat base material, in particular made of a biodegradable fibre material and/or paper; and
making the strip of integrally connected substantially flat clip bodies out of the substantially flat base material, in particular by means of die cutting.
